(19) United States
(12) Patent Application Publication
(10) Pub. No.: US 2002/0018889 A1
(43) Pub. Date: Feb. 14, 2002

(54) Plastic part

(76) Inventors: Achim Franck, Hamburg (DE); Andreas Junghans, Hamburg (DE); Bernd Lühmann, Norderstedt (DE)

Correspondence Address: William C. Gerstenzang, Norris McLaughlin & Marcus, P.A., 30th Floor, 220 East 42nd Street, New York, NY, 10017, US

(21) Appl. No.: 09/885,565

(22) Filed: Jun. 20, 2001

(30) Foreign Application Priority Data
Jul. 8, 2000 (DE) 100 33 399.0
Nov. 29, 2000 (DE) 100 59 324.0

(51) Int. Cl. B32B 7/12; B32B 23/02; B32B 15/04

(52) U.S. Cl. 428/343; 428/192

(57) ABSTRACT

A transparent plastic part intended for an adhesive bond with an adhesive sheet which deadheres without residue or damage by means of pulling in the direction of the bond plane, said part being provided with a UV absorber and configured such that it covers the adhesive sheet.

The invention relates to a plastic part for a bond with an adhesive sheet, pressure-sensitively adhesive on both sides, which is redetachable without residue or destruction by extensive stretching in the plane of the bond.

Elastically or plastically highly extensible (strippable) self-adhesive tapes which can be redetached without residue or destruction by means of extensive stretching substantially within the plane of the bond are known from U.S. Pat. No. 4,024,312, DE 33 31 016, WO 92/11332, WO 92/11333, DE 42 22 849, WO 95/06691, DE 195 31 696, DE 196 26 870, DE 196 49 727, DE 196 49 728, DE 196 49 729, DE 197 08 366, DE 197 20 145, WO 99/31193, and WO 99/37729.

They are frequently employed in the form of single-sidedly or double-sidedly pressure-sensitively adhesive film strips (adhesive tapes, adhesive strips), which preferably have a nonadhesive grip-tab region from which the process of detachment is initiated. Particular applications of such self-adhesive tapes can be found, inter alia, in DE 42 33 872, DE 195 11 288, U.S. Pat. Nos. 5,507,464, 5,672,402, and WO 94/21157. Specific embodiments are described, for example, in DE 44 28 587, DE 44 31 914, WO 97/07172, DE 196 27 400, WO 98/03601, and DE 196 49 636, DE 197 20 526, DE 197 23 177, DE 297 23 198, DE 197 26 375, DE 197 56 084, and DE 197 56 816.

Preferred areas of use of the abovementioned adhesive film strips include, in particular, the residuelessly and nondestructively redetachable fixing of light to moderately heavy articles in the home, workplace, and office segments. In these applications they replace conventional fastening means, such as hooks, pins, thumbtacks, nails, screws, conventional self-adhesive tapes, and liquid adhesives, for example, to name but a few. Key to the successful use of the abovementioned adhesive film strips is not only the possibility of the residueless and nondestructive redetachment of bonded articles but also their quick and easy bonding, and the secure hold they provide for the envisaged period of bonding.

Pressure-sensitive adhesive compositions suitable in accordance with the above-mentioned patent documents include primarily those based on natural rubber/resin mixtures, synthetic rubber/resin mixtures, and acrylate copolymers. In practical application, however, pressure-sensitive adhesive compositions based on styrene block copolymer/resin mixtures have certainly become established on the market. For instance, the Command® Adhesive products from Minnesota Mining and Manufacturing Co. Inc., St. Paul (USA), tesa® Power-Strips®, tesa® Power-Strips® mini, and tesa® Poster-Strips from Beiersdorf AG, Hamburg (D), and Plastofix® Formule Force 1000 from Plasto (F), all utilize a pressure-sensitive adhesive composition based on styrene block copolymer/resin mixtures.

A typical feature of pressure-sensitive adhesive compositions based on styrene block copolymer/resin mixtures is their susceptibility to thermal oxidative damage, ozone damage, and damage by UV radiation, which is significantly higher than that of, say, acrylate copolymers. This applies particularly to pressure-sensitive adhesive compositions based on those styrene block copolymers which comprise elastomer chains having unsaturated carbon-carbon bonds, as is the case, for example, for styrene block copolymers containing polybutadiene blocks and containing polyisoprene blocks. The formulation of pressure-sensitive adhesive compositions based on the aforementioned styrene block copolymers therefore typically includes measures for appropriate stabilization of the compositions. Accordingly, antioxidants and in some case light stabilizers as well are added to styrene block copolymers and tackifier resins as early as during their preparation processes. In order to generate sufficient protection against aging for, for example, the compounding of the adhesive composition, further processing steps, such as processing from the melt, for example, storage periods, and the period of use of the products containing the pressure-sensitive adhesive compositions in question, the pressure-sensitive adhesive compositions are also often typically admixed in the course of their preparation with two or more stabilizers, such as primary antioxidants, secondary antioxidants, carbon radical scavengers, metal scavengers, and different kinds of light stabilizers, for example.

A high aging stability is essential for pressure-sensitively adhesive film strips redetachable without residue or destruction by means of extensive stretching in the plane of the bond, especially with regard to their diverse applications. At the formulation stage it is necessary to employ appropriate additives. Moreover, the particular susceptibility of a grip tab protruding from the joint is recognized in the case of such adhesive sheets.

For instance, DE 42 22 849 describes a “strip of an adhesive film and its use for a re-releasable bond” (DE 42 22 849 C1-title), “one end of the strip being provided on both sides with a UV-opaque covering which at the same time serves as a tab for pulling” (DE 42 22 849 C1-claim 1). The purpose of the UV-opaque tab is to prevent tears when the strip is pulled for the purpose of parting (DE 42 22 849 C1-p. 2, lines 36, 37).

Moreover, the pack insert for tesa® Power-Strips®, tesa® Power-Strips® mini, and tesa® Poster-Strips reveals that they are unsuitable for bonds on window panes.

There has, then, been no lack of proposals as to how such adhesive sheets might be equipped in order for it to be possible for products of consistently high quality to be offered. And these proposals, and their results as reflected in the commercial products, are also undisputedly capable of improving these adhesive sheets relative to their original product variants. Notwithstanding this, however, there are cases again and again in daily practice in which evidently inadequate products are used, without any possibility of explaining why these products were in fact deficient, in respect for example of tack, or else in respect of reduced tip-shear stability of a bond produced with them. The peel strength of a bond produced with such products may also exhibit poor results, while any possibility of working out why this might be the case is absent. As a consequence, tears which occur continue to be a problem.

It was an object of the present invention to remedy this situation, and in particular to be able to offer the consumer a product of consistently high quality without disappointment as to the in-use performance of a bond produced with the product and as to its later dissolution, tears being a particular potential source of such disappointment.

This object is achieved by means of a plastic part as specified in more detail in the claims.

It has in fact become evident that the existing plastic parts of this kind, especially hooks, have not been given the level of attention they deserve, either in the patent literature or in the practical use of the various commercially available products. Indeed, despite all of the efforts made to date, tears occur again and again on subsequent detachment. Even the commercially available transparent hooks with 3M's Command Adhesive are without any UV protection, despite the fact that the adhesive composition of the adhesive films in question is based on an elastomer/resin mixture. The problem is unrecognized as such in the prior art. Nor, given the completely different directions taken by attempts to solve the problem of tearing, is it possible to derive from the prior art any indication as to whether such a problem occurs at all with transparent hooks and the like and as to how such a problem might be solved.

A comparative investigation of tesa® Power-Strips®, tesa® Power-Strips® mini, tesa® Poster-Strips, Command® Adhesive strips, and Plastofixe Formule Force 1000 adhesive strips (the pressure-sensitive adhesive compositions of said adhesive strips are all based on styrene block copolymer/resin mixtures) shows that all of the aforementioned adhesive strips experience a significant deterioration in their bond performance following UV exposure, ranging up to the complete loss of any adhesiveness whatsoever.

It is therefore evident that the existing commercial adhesive sheets redetachable without residue or destruction by means of extensive stretching in the plane of the bond lack the protection sufficient to render them capable of durably retaining their original bond performance even under UV exposure conditions as commonly occur in the home, workplace, and office environment, etc.

Adhesive Sheets

Adhesive sheets to be protected in accordance with the invention against UV degradation include in particular those of U.S. Pat. No. 4,024,312, DE 33 31 016, WO 92/11333, DE 42 22 849, WO 95/06691, DE 196 26 870, DE 196 49 727, DE 196 49 728, DE 196 49 729, and DE 197 08 366 which utilize pressure-sensitive adhesive compositions based on elastomer/resin mixtures. In particular, adhesive sheets of the invention utilize pressure-sensitive adhesive compositions based on polymeric dienes, such as natural rubber, synthetic polyisoprene and polybutadiene, for example. Moreover, adhesive sheets of the invention utilize pressure-sensitive adhesive compositions based on styrene block copolymers. Preferred styrene block copolymers include those containing elastomer blocks based on 1,3-dienes, such as polyisoprene, polybutadiene, isoprene-butadiene copolymers, and the partly or fully hydrogenated analogs corresponding to the aforementioned systems. Furthermore, adhesive sheets of the invention utilize pressure-sensitive adhesive compositions based on random copolymers of conjugated dienes and further polymerizable compounds, such as styrene-butadiene copolymers or acid-functionalized styrene-butadiene copolymers, to name but a few. Additionally, adhesive sheets to be protected in accordance with the invention against UV degradation utilize pressure-sensitive adhesive compositions based on polyolefinic elastomers. A further possibility for use in accordance with the invention are adhesive sheets with pressure-sensitive adhesive compositions based on mixtures of abovementioned elastomers and also those based on blends of abovementioned elastomers with further polymers.

Plastic Part

Particularly suitable in this respect are injection molding compounds, such as PMMA, POM, PC and polyesters, especially polystyrene, and/or mixtures of such components. The UV absorber may already be present in the injection molding compound, or is added to the compound together, for example, with a colorant batch. However, the UV absorber may also be present in a transparent coating material or in a protective sheet of that kind. Injection molding from polystyrene with a UV absorber of the benzotriazole type, however, is especially appropriate.

### EXAMPLE 1a

Glass-clear, colorlessly transparent plates (length×width=50×25 mm) having a thickness of 1.25+/−0.25 mm were injection molded from polystyrene (PS 158 K-BASF and Empera 123-BP Chemicals) and from the analogous grades provided by the manufacturer with UV absorber (hydroxyphenylbenzotriazole), namely PS 158 K 72819 UV and Empera 123 UV. Using adhesive strips redetachable without residue by means of stretching (single-layer adhesive sheets with the following formulation:

50 parts Foralyn 110 (Hercules), 50 parts Vector 4211 (Exxon Chemicals), 0.5 part Irganox 1010 (Ciba) with a tensile strength of 8 MPa and an elongation at break of 1 300% measured at a thickness of 650 μm) (L×W=50×20 mm), provided at one end on both sides with a grippable nonadhesive region (by coverage with a siliconized 23 μm PET film) (L×W=14×20 mm), these plates were bonded to glazed tiles in such a way that the grippable region reaches 1 mm into the joint. For this purpose, the adhesive strip (its upper face lined with release paper) was placed onto the tile and pressed on by rolling (10 m/s) over it 6 times using a 2 kg pressing roller. Following removal of the release paper, the above-described polystyrene plates were bonded by applied pressure (10 s, 100 N), acting uniformly and vertically on the entire adhesive composition, in such a way that the entire adhesive region of the adhesive strip was covered.

Specimens prepared in this way were subjected to UV exposure. The UV source used was an Atlas Suntest CPS+ equipped with a xenon tube. For all of the tests the level of irradiation set was 500 W/m² using a window glass filter. The distance between adhesive strip and radiation source was 15 cm. The storage in the Suntester was 8 days. The temperature during exposure was a constant 20±2° C. Within a period of 24 h following UV exposure, the specimens were assessed by extracting the adhesive strips extensively from the joints by hand, by pulling on the nonadhesive grip region (the maximum angle to the bond surface during detachment was 5°, the typical detachment speed approximately 10 cm/s). The assessment criterion was whether the adhesive strip could be detached in the manner described without residue or tearing.

Result:

All the specimens produced using the non-UV-stabilized raw material could not be detached without tearing.

All the specimens produced using the UV-stabilized raw material grades could be detached without residue or tearing.

### EXAMPLE 1b

Plates were produced by injection molding as in Example 1a, with the difference that a premix of PS 158 K (BASF) and Tinuvin 326 (CIBA) were added during the injection molding process to the polystyrene PS 158 K (BASF) used here, so as to give a Tinuvin 326 concentration of 0.1% or 0.2% or 0.3% in the plastic. Bonding, UV exposure, and assessment of the specimens took place as in Example 1a.

Result:

All the specimens produced without the use of Tinuvin 326 could not be detached without tearing.

All the specimens produced with addition of Tinuvin 326 to the raw material during injection molding could be detached without residue or tearing.

### EXAMPLE 2

Adhesive strips were bonded in accordance with Example la to glazed tiles using the commercially available tesa Power-Strips® fastening system, as described in DE 19537323, EP 766941, U.S. Pat. No. 5,913,480 or in DE 19729706 and EP 832588. The glass-clear, colorlessly transparent base plates used for this purpose were produced by injection molding from PS 158 K (BASF). Transparent colored hooks, produced by injection molding from PS 158 K (BASF) with addition of Tinuvin 326 (CIBA)-containing colorant (for designation and addition see below), were mounted onto the base plates in accordance with the abovementioned patents and were subjected to UV exposure in analogy to Example 1a. Thereafter, the hooks were removed from the base plates and the detachment characteristics were assessed in accordance with Example 1a. Result:

| c(Tinuvin 326) [%] | c(colorant) [%] | Detachability |
|---|---|---|
| 0.1 | 2 | 1 |
| 0.2 | 5 | 1 |
| 0.3 | 7.5 | 1 |
| 0 | 2 | 2 |
| 0 | 5 | 2 |
| 0 | 7.5 | 2 |

1 = detachable without residue or tearing
2 = not detachable without tearing
percentages are based on the finished plastic structures
Colorant: Fibaplast blau [blue] transparent 12039400 from Finke

What is claimed is:

1. A transparent plastic part intended for an adhesive bond with an adhesive sheet which deadheres without residue or damage by means of pulling in the direction of the bond plane, said part being provided with a UV absorber and configured such that it covers the adhesive sheet.

2. The plastic part as claimed in claim 1, which is glass-clear.

3. The plastic part as claimed in claim 1, whose surface has been rendered matt or eroded.

4. The plastic part as claimed in claim 1, which is transparent to UV radiation below 420 nm.

5. The plastic part as claimed in claim 1, which covers the adhesive sheet and also its grip tab.

6. The plastic part as claimed in claim 1, wherein the UV absorber is present within the plastic itself.

7. The plastic part as claimed in claim 1, which is an injection molded part for which the UV absorber is added in the course of injection molding or is already present within the injection molded plastic.

8. The plastic part as claimed in claim 1, wherein the UV absorber is in a transparent coating material or in a transparent protective sheet on the plastic part.

9. The plastic part as claimed in claim 1, which is colorless or colored.

10. The plastic part as claimed in claim 1, wherein the adhesive sheet is based on elastomer/resin mixtures.

11. The plastic part as claimed in claim 1, which is made of PMMA, POM, PC, polyester or, in particular, polystyrene or mixtures thereof.

12. The plastic part as claimed in claim 1, which is a hook.

13. The use of a plastic part as claimed in any of claims 1-12 for UV-protected adhesive bonding with a pull-release adhesive sheet.
